(19) United States
(12) Patent Application Publication
(10) Pub. No.: US 2025/0391582 A1
(43) Pub. Date: Dec. 25, 2025

(54) Method and device for the dissolution and transfer of radon and other impurities from an atmosphere or gas stream

(71) Applicants: Daniel Deocampo, Avondale Estates, GA (US); Richard Jensen, Atlanta, GA (US)

(72) Inventors: Daniel Deocampo, Avondale Estates, GA (US); Richard Jensen, Atlanta, GA (US)

(73) Assignee: Nalari Scientific, LLC, Atlanta, GA (US)

(21) Appl. No.: 18/749,810

(22) Filed: Jun. 21, 2024

(51) Int. Cl. G21F 9/02; B01D 53/14; B01D 53/18; F24F 8/117; F24F 8/70

(52) U.S. Cl. CPC G21F 9/02; B01D 53/1425; B01D 53/18; F24F 8/117; F24F 8/70; B01D 2252/30; B01D 2257/11; B01D 2258/06; B01D 2259/4508

(57) ABSTRACT

A method and device for the dissolution of radon into an ionic liquid for filtration of a gas stream, removal of radon from an environment, storage of radon, use in chemical processes, and many other purposes. In the primary embodiments, the invention is a filtration system using gas scrubbing, stripping, sparging and similar processes for removing radon and/or other impurities, pollutants or contaminants from a habitable space.

### CROSS REFERENCE TO RELATED APPLICATION

This application claims the benefit of priority to U.S. Provisional Application No. 63/522,735 filed Jun. 23, 2023, which is incorporated herein by reference.

### FIELD

The invention relates to the dissolution of radon gas into an ionic liquid, both generally and as a specific means for filtration of radon from a volume of air.

### BACKGROUND

Poor air quality in many different settings continues to threaten human health worldwide. Contaminants include particulates, inorganic compounds, volatile organic compounds, bacteria and viruses, radioactive particles, and other materials. One example of an indoor air contaminant is radon-222 (“radon”), a naturally-occurring isotope that is the radioactive decay product of radium-226, and part of a chain of decay products of uranium-238. Unlike all the other isotopes in the uranium-238 decay chain, which are solids, radon is a gas. It therefore can emanate out of rocks, sediment, or soils, and infiltrate into confined air spaces, where it may be inhaled (Dai et al., 2019), and it cannot be captured by conventional filtration.

Numerous approaches are available to mitigate radon hazards, as described by Khan et al. (2019), but their success is variable and many fail to achieve the desired level of protection. Methods include active or passive sub-slab depressurization, impermeable membranes, active or passive ventilation, and home pressurization. Sub-slab active depressurization is generally seen as the most effective, but it is also the most expensive, especially in retrofitting, and it is not practical in many settings.

Although radon is only sparingly soluble in water, and is generally not reactive, it will dissolve in some fluids, such as perfluorinated solvents, as shown by Lewis et al. (1987). Such organic chemicals are not suitable for household use, however, for several reasons, including reactivity with water and oxygen, and relatively high equilibrium vapor pressures. Other working fluids for the absorption or dissolution of radon have been disclosed, including hydrocarbon oils of mineral, vegetable, or animal origin, as disclosed by Gross (U.S. Pat. No. 5,743,944) and Meyer (U.S. Pat. No. 9,539,537). These, too, have the disadvantage that they can degrade, evaporate, or oxidize.

The development of ionic liquids (“liquid ionic compounds”, “molten salts”, “liquid salts”) in recent years has opened new frontiers in innovation due to the novel and unexpected behaviors of these fluids, especially as environmentally-benign industrial solvents. Ionic liquids are composed of cations and anions that are ionically bonded, with a freezing/melting point below room temperature. Although ionic liquid properties are still poorly understood, their unique, tunable properties such as hydrophobicity, molecular polarization, internal free space, viscosity, surface tension, and other properties may allow effective absorption of radon under optimal conditions. Their extremely low equilibrium vapor pressures ensure that they will not contaminate the air, and they are generally considered to be non-toxic.

The term “ionic liquid” (and other equivalents) here refer to one or more liquids, singularly or as a mixture, composed of ionic salts that are liquid at room temperature, also known as “liquid ionic compounds”, “molten salts”, or “liquid salts”. Some embodiments of the invention use a pure single ionic liquid, whereas other embodiments use a mixture of two or more ionic liquids, or other liquids. Mixtures of ionic liquids in some embodiments possess the individual properties of the constituent pure components, and in some embodiments mixtures of ionic liquids possess emergent properties only found in the mixtures and not found in the pure components.

Each ionic liquid molecule is composed of one cation, ionically bonded to an anion. Ionic liquid cations are composed of a core unit with one or more groups or chains of groups attached to it, with variable positions of attachment on the core unit. Possible cation core units include, but are not limited to, pyrolidinium, pyridinium, pyridazinium, piperidinium, imidazolium, ammonium, guanidinium, morpholinium, phosphonium, sulfonium, and others. Groups or chains of groups attached to the core units may include, but are not limited to, methyl, ethyl, propyl, butyl, pentyl, hexyl, heptyl, octyl, nonyl, decyl, dodecyl, or other groups or chains of groups, comprising, possibly but not exclusively, homogeneous hydrocarbon groups or chains of groups, or heterogeneous hydrocarbon groups or chains of groups containing, singly or multiply, fluorine, nitrogen, sulfur, phosphorous, or other heterogeneous component. Possible ionic liquid anions include but are not limited to chloride, bromide, iodide, acetate, thiocyanate, hexafluorophosphate, tetrafluoroborate, ethyl sulfate, methyl sulfate, trifluoro-acetate, trifluoromethylsulfonate, bis(trifluoromethylsulfonyl)imide, alkyl sulfate, triflate, dicyanimide, bis(pentafluoroethylsulfonyl)imide, diethyl-phosphate, tris(pentafluoroethyl)trifluorophosphate, fluorinated sulfonates, trifluoromethanesulfate, pentanoate, propionate, perfluorobutanesulfonate, perfluoropentanoate, or other anion.

Following is a description of the thermodynamic background governing the dissolution of radon in an ionic liquid, comprising the general conditions of said dissolution. The below description should not be construed as an exposition of any particular system or environment, which may be furthermore affected by particulars of temperature, pressure, gas composition, liquid composition, competitive dissolution, reaction kinetics, gas diffusion, adsorption, complexation, or other properties or processes.

In accordance with Henry's Law, the mass of a gas dissolved in a liquid is proportional to the partial pressure of said gas at equilibrium with the surface of said liquid. Song et al. (2020) showed that the noble gasses Ar, Kr, and Xe are soluble in several ionic liquids, and that the solubilities of said gasses are affected by both enthalpic (i.e. molecular interactions) and entropic (i.e. molecular ordering) considerations. Our model calculations based on the Van der Waals radius, the polarizability, and the first ionization energy of radon all indicate that, far from being the non-reactive, inert, and sparingly soluble gas it is commonly considered to be, radon is likely more soluble than any of the other noble gases, especially in a liquid optimized for enthalpic and entropic solvation (FIG. 1).

The equilibrium solubility of a gas in a liquid is commonly expressed as

$$X = \frac{P}{{K}_{H}} \qquad Equation 1$$

where X is the mole fraction of moles of gas dissolved per moles of liquid solvent plus moles of dissolved gas, P is the partial pressure of the gas in the atmosphere at equilibrium with the liquid, and K_{H} is the Henry's Law constant for the gas-liquid system, in the units of pressure P. When the number of moles of dissolved gas is much smaller than the number of moles of liquid, the mole fraction is approximated as the number of moles of dissolved gas per mole of liquid. The molarity of the solution, therefore, in moles of radon per liter of ionic liquid is

$${M}_{Rn - IL} = X \times {MV}_{IL} \qquad Equation 2$$

where MV_{IL} is the molar volume of the ionic liquid in moles per liter, or by application of Equation 1,

$${M}_{Rn - IL} = \frac{P {MV}_{IL}}{{K}_{H}} . \qquad Equation 3$$

Various expressions for P can be derived through the use of the Ideal Gas Law,

$$PV = NRT \qquad Equation 4$$

where P is the pressure in Pa, V is the volume of the gas in m³, N is the number of moles of gas, R is the universal gas constant (8.3145 J/mol K), and T is the temperature in Kelvins. In studies of radon gas, the concentration of radon is often expressed in terms of radioactivity-picoCuries per liter (pCi/L) in the US and becquerels per cubic meter (Bq/m³) in most of the rest of the world. One Bq is equal to one disintegration per second by radioactive decay, and one pCi is equal to 0.037 disintegrations per second. The number of disintegrations per second, or activity, is proportional to the number of radon atoms n present and the radioactive decay constant k, which is 10^{-5.68} for radon-222:

$${α}_{Rn} = {k}_{Rn} {n}_{Rn} . \qquad Equation 5$$

This expression can then be substituted into the Ideal Gas Law, and adjusted to reflect the number of moles of Rn by dividing by Avogadro's number (N) to yield

$${P}_{Rn} = \frac{( 0.037 disintegrations per sec ) ( 1000 L ) [ {α}_{Rn} ] RT}{( 1 {m}^{3} ) {k}_{Rn} {N}_{Av}} . \qquad Equation 6$$

The brackets in [α_{Rn}] indicate the concentration of radioactivity, in pCi/L, as discussed above. Substituting this into Equation 3, the molarity of radon in the ionic liquid at equilibrium becomes

$${M}_{Rn - IL} = \frac{37 RT [ {α}_{Rn} ] {MV}_{IL}}{{K}_{H} {k}_{Rn} {N}_{Av}} . \qquad Equation 7$$

This relationship defines a closed system at thermodynamic equilibrium, with radon atoms partitioned between the ionic liquid (M_{Rn-IL} in moles/L) and the gas phase ([α_{Rn}] in pCi/L). The number of moles of radon dissolved in the ionic liquid then is

$${N}_{Rn - IL} = {M}_{Rn - IL} \times {V}_{Rn - IL} = \frac{37 RT [ {α}_{Rn} ] {MV}_{IL} {V}_{IL}}{{K}_{H} {k}_{Rn} {N}_{Av}} \qquad Equation 8$$

and the number of moles of radon in the atmosphere is

$${N}_{Rn - Atm} = \frac{{P}_{Rn} {V}_{Atm}}{RT} = \frac{37 RT [ {α}_{Rn} ] {V}_{Atm}}{{k}_{Rn} {N}_{Av} RT} = \frac{37 [ {α}_{Rn} ] {V}_{Atm}}{{k}_{Rn} {N}_{Av}} . \qquad Equation 9$$

$$Because$$

$${N}_{Rn - TOT} = {N}_{Rn - Atm} + {N}_{Rn - IL} , \qquad Equation 10$$

$$therefore$$

$${N}_{Rn - TOT} = \frac{37 [ {α}_{Rn} ] {V}_{Atm}}{{k}_{Rn} {N}_{Av}} + \frac{37 RT [ {α}_{Rn} ] {MV}_{IL} {V}_{IL}}{{K}_{H} {k}_{Rn} {N}_{Av}} = \frac{37 [ {α}_{Rn - init} ] {V}_{Atm - init}}{{k}_{Rn} {N}_{Av}} . \qquad Equation 11$$

where [α_{Rn-init}] and V_{Atm-init} indicate the initial activity concentration of radon and volume of atmosphere, respectively, prior to any dissolution of radon in the ionic liquid, at which time

$${M}_{Rn - IL - init} = 0 \qquad Equation 12$$

In other words, the sum of the numbers of moles of radon in the ionic liquid and gas at equilibrium are equal to the initial number of moles in the gas. This equation then simplifies to

$$[ {α}_{Rn} ] = \frac{[ {α}_{Rn - init} ] {V}_{Atm - init}}{( {V}_{Atm} + \frac{RT {MV}_{IL} {V}_{IL}}{{K}_{H}} )} , \qquad Equation 13$$

providing the equilibrium value to which radon activity concentration in the air will drop, after equilibrating with an introduced ionic liquid. The number of moles of radon in the ionic liquid can then be calculated using Equation 8. Finally, we define the mole fraction

$$γ = \frac{{N}_{Rn - IL}}{{N}_{Rn - TOT}} \qquad Equation 14$$

as the radon partition coefficient, indicating the equilibrium fraction of radon gas dissolved in the ionic liquid.

We coupled the thermodynamic model of radon dissolution in an ionic liquid expressed by Equation 13 to models of airflow to facilitate the design of innovative radon capture devices and methods embodying the invention. FIG. 2 shows one example of such a coupled model, accounting for the air within a confined space (eg. a basement), fresh air flowing or leaking in, exhaust air flowing or leaking out, contaminated air flowing or leaking in, air flowing into a contaminant capture device, air returning from the contaminant capture device to the confined space, and circulation of ionic liquid between the capture device and a degassing environment to regenerate the ionic liquid. The model shown in FIG. 2 and discussed here is only one example, and should not be construed as describing any particular environment, nor should it be construed as limiting the invention or its embodiments in any way. Furthermore, the model shown in FIG. 2 is applicable to the dissolution of any undesired gas in ionic liquids, given the appropriate thermodynamic constants particular to the application. Based on mass balance considerations, at steady state, the absolute amount of radon infiltrating into a confined space is equal to the amount of radon leaking out plus the amount (if any) captured by a contaminant capture system. Thus,

$$[ {α}_{ss} ] = \frac{{α F}_{inf}}{( ( ACM ) {V}_{cs} + {VF}_{cap} ( 1 - \frac{{V}_{atm - init}}{( {V}_{atm} + {C}_{IL} ) ( {V}_{atm - init} / {V}_{atm} )} )} , \qquad Equation 15$$

where [αₛₛ] is the steady state radon radioactivity concentration in pCi/L, αF_{inf} is the flux of radon radioactivity infiltrating into the confined space in pCi/min, ACM is the total number of air changes per minute exchanging fresh air (both natural and forced) into the confined space in min⁻¹, V is the volume of the confined space in L, VF_{cap} is the air flux of confined space air into the capture device in L/min, Vₐₜₘ and Vₐₜₘ₋ᵢₙᵢₜ are as shown in Equations 11 and 13 in m³ and C_{IL}, is a simplification of RTMV_{IL}V_{IL}K_{H}⁻¹ as shown in Equation 8. Note that the additional compression ratio term (Vₐₜₘ₋ᵢₙᵢₜ/Vₐₜₘ) accounts for expansion of air released from the device, if applicable. This will occur if the device compresses air during gas dissolution, and/or decompresses air (i.e. applies a vacuum) upon degassing. If the device does not appreciably alter the air density by air compression or application of vacuum, then this term cancels to 1. The amount of flux of infiltrating radon radioactivity can be determined by solving for αF_{inf} given an observed steady state maximum of [αₛₛ]=[αₘₐₓ], estimates of ACM and V_{CS}, and assuming zero capture. ACM (or ACH, Air Changes Per Hour) is a standard parameter in indoor air quality studies, often based on a measurement of ACH₅₀, as discussed in Mata et al. (2022). For example, a 150,000 L basement with [αₘₐₓ]=10 pCi/L and ACM=0.003 has αF_{inf}=4500 pCi/min. An embodiment of the invention capable of lowering the basement radon level to [αₛₛ]=2 pCi/L would need to cycle approximately 2450 L/min of basement air, assuming a one-to-one volume ratio of air to fresh ionic liquid in the device, MV_{IL}=1.14 moles/L, K=10^{5.78} Pa, and no air compression factor.

On a continuing basis, the ionic liquid that becomes charged with radon may be regenerated as shown in the model of FIG. 2, wherein it is moved to an environment with minimal airborne radon, such as an exterior environment. In such an environment, in which [α_{Rn}] approaches zero, the ionic liquid degasses the radon it carries, releasing it to the environment, before returning to the capture device with refreshed capacity to capture additional radon. A number of different embodiments of the invention can accomplish this degassing step, including, but not limited to, contacting radon-bearing ionic liquid with exterior air that is pumped into an interiorly located chamber or other variation of arrangement of components. Other approaches can be used involving lowering the atmospheric pressure in the degassing chamber, such as through applying a vacuum. In some embodiments, the thermodynamics of radon dissolution are used to degas it for the purpose of removing radon permanently from the confined space.

The above thermodynamic analyses show the controlling factors for the dissolution and release of radon into and out of an ionic liquid, for the purpose of designing methods and/or devices for the remediation of radon contaminated spaces or other capture of radon. A similar approach can be made in the consideration of other air contaminants for which ionic liquids are suited for air purification. These include gasses for which ionic liquids have suitable solubilities, including carbon dioxide, carbon monoxide, various hydrocarbons, hydrogen sulfide, ethylene oxide, and other gasses. Moreover, with their relatively high viscosity, low surface tension, and high electrical conductivity, ionic liquid surfaces can potentially effectively intercept particulates and remove them from vapor streams. This may include particles that are either electrostatically charged or neutral, hydrophobic or hydrophilic, including dust, pollen, soot, dander, and pathogens such as viruses and bacteria.

This is specifically relevant to environments, such as residential and commercial buildings in which radon is combined with other pollutants or impurities in the air. These other impurities are known to negatively impact human health, even causing death in extreme cases (Van Tran et al., 2020), and they include, but are not limited to, particulate matter such as PM10 and PM2.5, smoke, pathogens (i.e. viruses and bacteria), airborne organisms, other biological materials (e.g. dander, pollen), organic compounds, inorganic compounds, and radioactive materials. Although ventilation and discharge of such contaminants to external environments may be preferred, this option is often not available because it would cause the loss of heated or cooled interior air, thus dramatically increasing heating or cooling costs. Worldwide efforts to increase energy efficiency have also dramatically increased the insulation and sealing of houses and other spaces, thereby increasing the concentration of indoor air pollutants and leading to greater human health impacts. Tightly-sealed homes and other spaces must therefore have some system of remediation to clean the air of hazardous impurities to protect human health. As discussed by Mata et al. (2022), numerous options are currently available for removing air pollutants, including filtration, adsorption, oxidation, and ionization, all of which have challenges of coast of materials, cost of operations, effectiveness, throughput potential, and pollutant applicability and selectivity. The present innovation is an advance over existing technologies and addresses many of these challenges, as described in some respects herein.

### SUMMARY

The invention described herein relates to dissolving radon gas into an ionic liquid in its most general form. This may serve the purposes of filtration, storage, transport, facilitating chemical processes involving radon, and many other desirable activities. Particular embodiments of the invention relate to the filtration of a volume of air containing radon to substantially remove the radon from that volume of air. In one embodiment the filtration is achieved by moving the air containing radon through a bubble column of ionic liquid to dissolve the radon into the ionic liquid. The ionic liquid is circulated continuously to a degassing chamber where it is contacted with air containing no radon or substantially less radon, then circulating it back to the bubble column for dissolving more radon.

In another embodiment a scrubbing system is used to dissolve the radon in the ionic liquid. This system may contain packing materials to increase the surface area of the phase interface between the gas stream and the ionic liquid to increase the amount of dissolution. This system follows the same degassing process as the embodiment using the bubble column.

In another embodiment the system uses encapsulated ionic liquids in a packed-bed scrubber system to dissolve the radon into the ionic liquid. In this embodiment the ionic liquid is degassed of radon by switching the air stream moving through the packed-bed to an air stream containing no radon or substantially less radon than the air stream being filtered of radon.

The inventors further envision all the embodiments herein as being able to be integrated with an air conditioning system so that a habitable environment can be filtered of radon at the same time as the air in that environment is being heated, cooled or circulated through the air conditioning system.

Finally, the inventors also claim the method of dissolving radon from a volume of air into a volume of ionic liquid. Further embodiments of this method include the method of using a bubble column, a scrubber, or a packed-bed scrubber to filter the radon from the volume of air, each of which may be integrated with an air conditioning system.

### DESCRIPTION OF THE DRAWINGS

FIG. 1. Plots of experimentally determined solubility data from Song et al. (2020), for xenon, krypton, and argon, with polynomial fitted curves based on physical data on atomic radius, polarizability, and ionization energy for these gasses. Solubility was determined in ionic liquid [P66614][TMPP] (Trihexyltetradecylphosphonium bis(2,4,4-Trimethylpentyl)phosphinate). Extrapolations to radon are based on the theoretical model developed by the inventors.

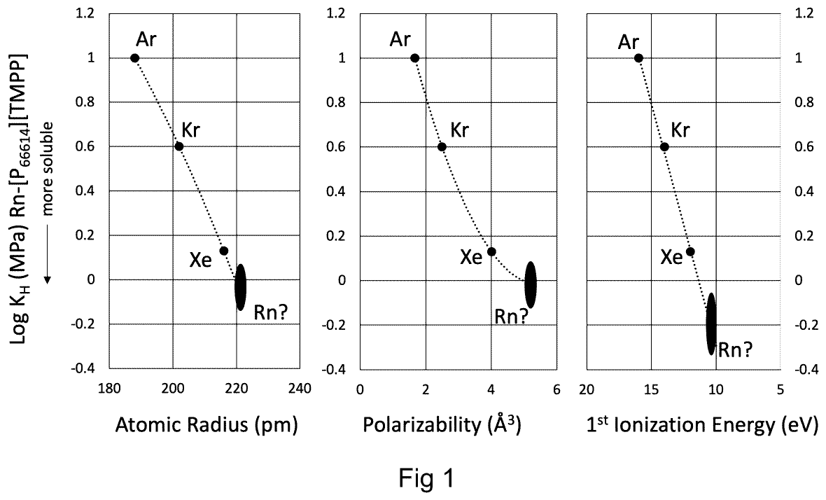

FIG. 2. Graphical depiction of the mathematical model developed by the inventors to show the efficacy of the invention described herein under various operating conditions and parameters. This is a general model specifically related to radon, but is easily adaptable to any other gaseous element or compound by changing the constants and parameters used specifically for radon in the equations.

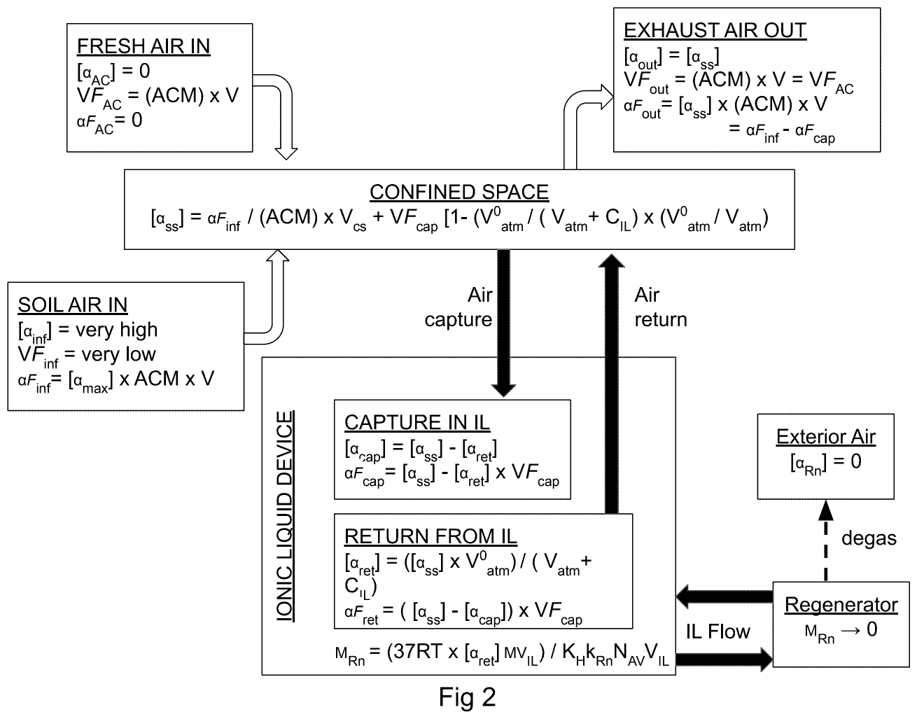

FIG. 3. Schematic diagram of one embodiment of the invention, depicting contaminated air intake/inlet port 50; cleaned air return conveyance 60; a contaminant capture chamber 20; a conveyance 180 of regenerated ionic liquid from a degassing chamber 150 to the contaminant capture chamber 20; a conveyance of contaminant-laden ionic liquid 190 from a contaminant capture chamber 20 to a degassing chamber 150; an ionic liquid trap 25 for sampling or storage, or analytical instrumentation 200 for analysis of ionic liquids; a conveyance 210 of regenerative air into the degassing chamber 150; and a conveyance 45 of degassing exhaust air from the degassing chamber 150 to an external environment 220, a degassing exhaust trap 230 for sampling or storage, or analytical instrumentation 55 for the analysis of degassing exhaust.

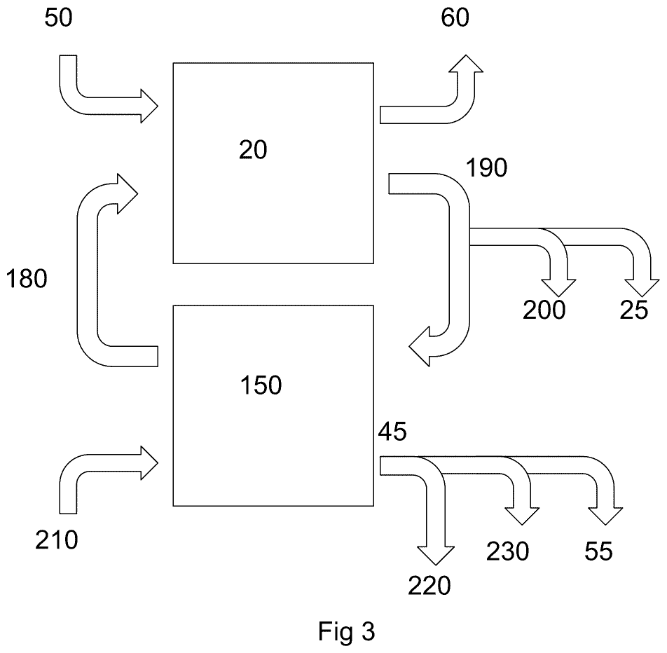

FIG. 4. Schematic diagram of one embodiment of the invention, integrated with a household HVAC system, depicting an HVAC air handler 220 that discharges heated or cooled air; a number of air registers 65 that discharge air into habitable spaces; an air return 230 that provides air into the HVAC system; and invention components 20, 45, 50, 60, 150, 180, 190, and 210 as described for FIG. 3. In the depicted embodiment, all components of the system are co-located with the HVAC air handler and duct work, comprising part of an HVAC system 170, in the attic 75 of the house.

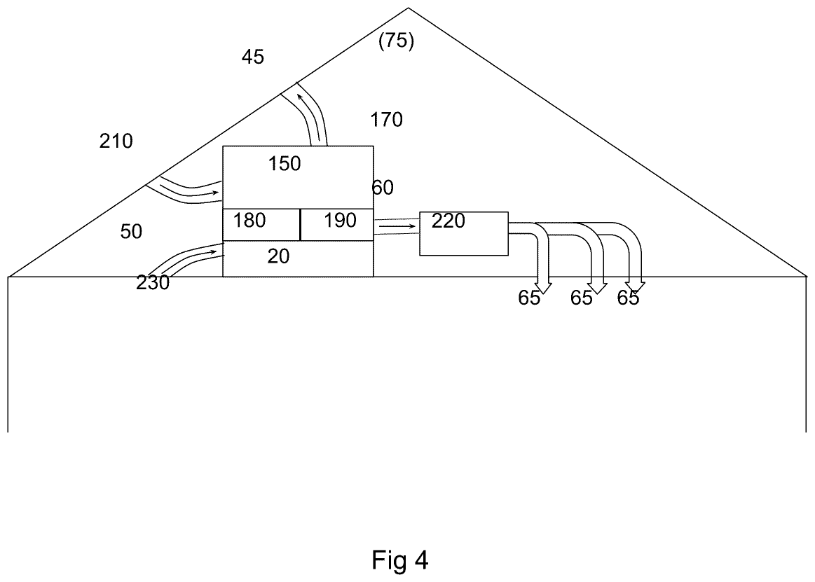

FIG. 5. Drawing of a bubble column embodying the invention, including the overall radon capture device 10, capture chamber 20, ionic liquid 30, air pump providing movement of air 40, air intake/inlet port 50, cleaned air outlet port 60, bubble column 70, diffuser or sparger 80 releasing bubbles at the base of the ionic liquid column, tank containing the ionic liquid 90, and mist/droplet eliminator 100.

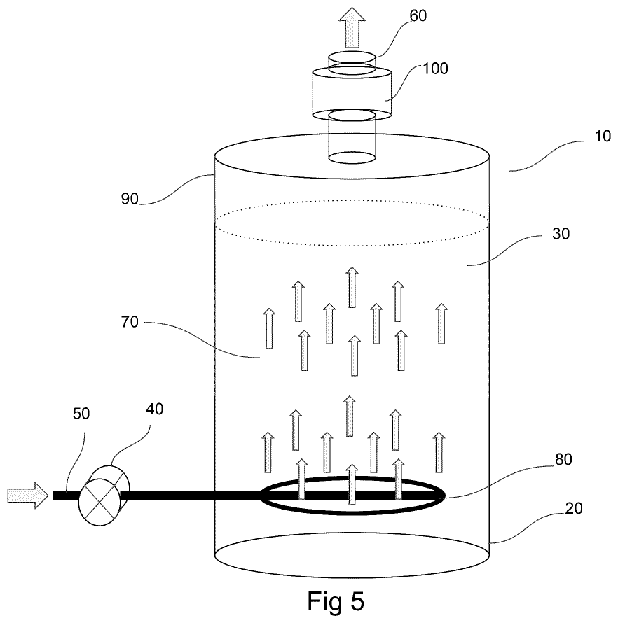

FIG. 6. Drawing of ionic liquid based air scrubber embodying the invention, including capture chamber 20, air pump 40 and air intake/inlet port 50 where air enters the unit, cleaned air outlet port 60, tank 90, mist/droplet eliminator 100, packing materials 120, ionic liquid outflow port 130, and ionic liquid inflow port 140 allowing ionic liquid to flow into the device and be sprayed or distributed downward onto the packing materials and through the airflow.

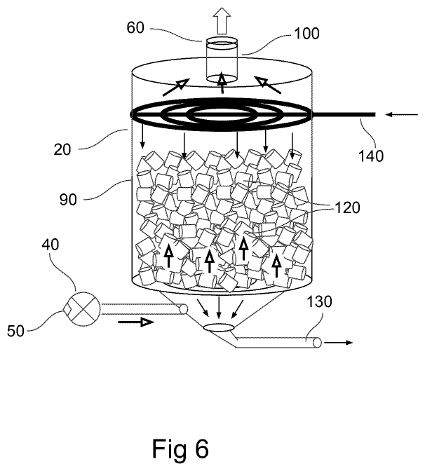

FIG. 7. Drawing of a packed bed embodying the invention, including the capture chamber 20 filled with beads of encapsulated ionic liquids 160, air intake 50, and air outlet 60.

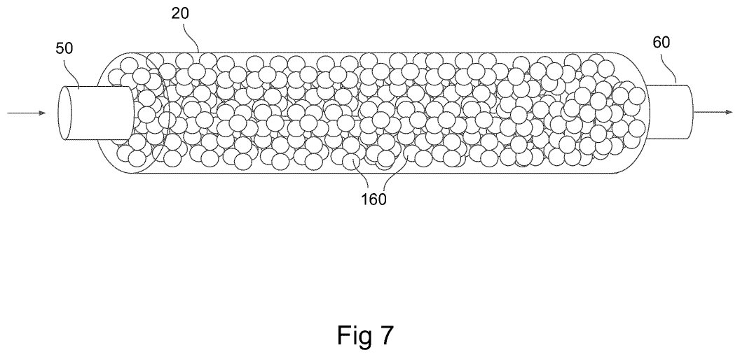

### DETAILED DESCRIPTION

The present invention comprises many different embodiments, all of which relate to the dissolution of radon into ionic liquids. Some embodiments include the dissolution of other gases, molecules, elements, compounds, or particles into ionic liquids in addition to radon.

In the first embodiment, a volume of air containing radon is moved through a radon capture device 10 containing an ionic liquid 30, bringing the gas stream and the ionic liquid 30 into contact through one of various methods including those described infra, leading to the dissolution of radon into the ionic liquid, thus removing it from the gas stream that is returned to the original volume of air with a reduced level of radon.

In this embodiment, the radon-containing volume of air is most likely that within an inhabitable space, such as a home, office, industrial, or other commercial or residential building, however the inventors envision many other uses for the invention including the various embodiments thereof presented herein. The radon-containing air is introduced into the radon capture device by a means for the movement of air 40 located within the capture device 10. The means for the movement of air 40 may be located at the air intake 50 location prior to the radon-capture mechanism in order to push air. through the capture device 10, it may be located closer to the cleaned air cust outflow 60 after the radon capture mechanism in order to pull air through the capture device 10, or it may be located at any point in between.

The means for the movement of air 40, also referred to as a pump, may vary between the different embodiments, and is envisioned to include all conceivable methods of moving air from one volume to another, such as: pumps of every variety, including but not limited to, turbo pumps, screw pumps, rotary vane, centrifugal, impeller, peristaltic, membrane-based pumps, fans of all varieties, and any other air-movement device.

Once the radon-containing air has entered the capture system 10 it will be contacted with the ionic liquid 30 in one or more of several different methods. The methods of contact between the gas stream with the liquid varies between embodiments due to the specific needs and parameters of each embodiment. Those needs and parameters may include flow rate of the gas stream, amount of radon in the gas stream, intended location of the device relative to the volume of air to be cleaned of radon (e.g. free-standing in a room, integrated into an HVAC system, and/or existing duct work, partially inside the volume of air and partially outside, or any other way it may be situated), the temperature of the gas stream, and many other potential factors.

One embodiment utilizes a bubble column 70 designed to contact the gas stream with the ionic liquid. In this embodiment the gas is pumped through a diffusor 80 at the bottom of a tank 90 of ionic liquid 30. The pump 40 may be situated either before or after the diffusor 80, so as to either push or pull the gas stream through, or it may contain two or more pumps 40 situated both before and after the diffuser 80 and bubble column 70. The bubble column 70 and the diffusor 80 are designed to ensure maximum diffusion of the gas into the ionic liquid 30, with an optimally high phase interface surface area and sufficiently tall column to achieve the required residence time. The diffusion mechanism 80, referred to as a sparger or diffuser, is a main component of the design of all embodiments involving a bubble column 70. The various embodiments envisioned by the inventors include a wide array of means for diffusion of gas into a liquid, which may include any from the following list, intended to be me exemplary not exhaustive or limiting in scope: fine and very fine sprayers, coarse and very coarse spargers, porous spargers, membrane spargers, needle spargers, sieve tray spargers, perforated plate spargers, annular gap spargers, pipe spargers, spider spargers, ring spargers, multiple nozzle and single nozzle spargers, along with any other similarly situated spargers or diffusion mechanisms not listed.

In most embodiments, the diffuser 80 is located at the gas stream inlet 50 at the bottom of the bubble column 70, which is a tank, vat, pipe, or other similar container 90 of ionic liquid 30. The dimensions and the geometry of the bubble column 70 may vary between the various embodiments, but will be such that the residence time of the radon-containing gas provides for a sufficient amount of contact to dissolve radon as required by the diffusion and dissolution kinetics. Once the gas stream of radon-containing air has been cleaned or stripped of radon, it passes through a device commonly referred to as an eliminator 100, which is designed to ensure no droplets or mist of the ionic liquid escapes with the gas stream. In some embodiments, this may be accomplished by using an airflow pathway that has a geometry and internal surface topology such that it prevents any ionic liquid that becomes entrained in the gas stream from exiting the device. Various other mechanisms to accomplish this may be used, such as screens or other filters.

In another embodiment of the method and device presented in this disclosure, the means for contacting the gas stream and the ionic liquid is a gas stripper, scrubber, or similar device 110 to those as described infra. Generally, a scrubber or stripper 110 is a device using a method of contacting the gas and liquid phases through the creation of droplets or mist within the gas stream instead of bubbling the gas stream through the liquid phase. Various means for gas scrubbing that may be used are spray towers, cyclonic spray towers, centrifugal scrubbers, dynamic scrubbers, tray towers, Venturi scrubbers, orifice scrubbers, packed bed scrubbers, random packed column scrubbers, stacked packed column scrubbers, tray-based column scrubbers, packed bed scrubbers, and other similar scrubbers. In some embodiments, the scrubber system 110 may use encapsulated ionic liquids 160, though in most preferred embodiments the ionic liquid 30 is free flowing. In scrubber-based embodiments with free flowing ionic liquid 30 contacting the radon-contaminated gas stream, the ionic liquid 30 is sprayed, misted, or otherwise diffused into the radon capture chamber 20 in which it contacts the gas stream. In these embodiments, the capture chamber 20 may be filled with a variety of different packing materials 120 designed to increase surface area of contact between the gas stream and the ionic liquid 30, increase path length of the gas stream through the capture chamber 20, and increase residence time of both the ionic liquid 30 and the gas stream. This packing material 120 may comprise a collection of individual structured shapes, large structural components, random packing shapes and material, such as Raschig rings, along with a wide variety of similar shapes and materials. Once the ionic liquid 30 has passed through the packing material and become saturated with radon and other contaminants, it collects in a pool at the bottom of the capture chamber 20 or is drained from the capture chamber 20 through an outflow port 130 situated to remove the ionic liquid and circulate it into the degassing apparatus 150.

In all embodiments of the invention, the radon capture chamber 20 may be pressurized to enhance dissolution of radon and/or other contaminants in the ionic liquid.

In some embodiments of this method and device, the ionic liquid 30 will be continuously circulating between a degassing chamber 150 and the radon capture chamber 20 in order to allow for the continuous capture of radon and other impurities in the gas stream. In other embodiments, especially those embodiments using encapsulated ionic liquids 160, the ionic liquid 30 may be degassed in the capture chamber 20 by switching the air flow between a gas stream containing radon and/or other impurities and a gas stream with less radon and other impurities.

In the embodiments using a degassing chamber 150, the ionic liquid 30 is pumped from the capture chamber 20 into the degassing chamber 150 and contacted with an environment or gas stream that contains less radon and/or other impurities. The mechanism or method of contacting the ionic liquid 30 with the environment or gas stream will be such that it maximizes surface area for the purpose of degassing. All of the means for contacting a gas stream with a liquid listed supra, such as scrubbing, bubbling, sparging, plus any other methods of contacting a gas and a liquid commonly used in dissolution and filtration technologies, are possible means for degassing in the degassing chamber. In some embodiments the means for degassing may include moving the ionic liquid into an atmosphere that is at substantially lower pressure, partial vacuum or full vacuum. Such a vacuum may also be produced across a semi-permeable membrane, so as to allow the passing of gas degassing from the ionic liquid, but prevent loss of the ionic liquid to the vacuum pump. There may be other means or mechanisms that can be used to degas the ionic liquid 20 not mentioned supra, such as those involving membranes, semi-permeable membranes, filters, gas/liquid contactors, or other similar devices.

In most embodiments, the gas stream of non-radon-contaminated air used for degassing, whether it be external air or air from another source, is passed through a filter to remove particulate matter prior to contacting the ionic liquid 30. This filtration should be optimized for maintaining the long-term functionality of the capture device 10. After the radon has been removed from the ionic liquid 30 through the degassing process, it is expelled from the system by the outflow of the air stream used for degassing. This allows for the ionic liquid 30 to be continually refreshed and returned to the radon capture chamber 20 with a regenerated ability to dissolve more radon and other contaminants.

In some embodiments of the method and device described supra, the radon removal device 10 may be integrated into an air conditioning, air circulation, or heating, ventilation, and air conditioning system, referred to as an HVAC system 170. In these embodiments, the invention is intended to filter radon and other contaminants from the air circulating a habitable space. This will allow for the habitable space to be sealed from the external environmental air to a much higher degree while still keeping the interior air free from radon and other impurities and contaminants. In these embodiments, the dissolution and degassing process acts as a selective filter for the interior air by exchanging radon, volatile organic compounds (VOCs), carbon dioxide, and other substances with the outside air wi without losing desired gasses such as oxygen and nitrogen due to their roughly equal presence in the external and internal air. This process of filtration will produce an interior environment that is substantially equal to the “fresh” air environment outside without actually having to exchange any air between the internal and external environments. through venting and replacement. While some thermal transfer may take place between the ionic liquid and gasses through liquid/gas contacting, it will be minimal compared to that of direct venting and replacement.

In these embodiments, the integration of the air filtration and radon capture device 10 into the HVAC system 170 may be accomplished by a variety of different methods. These include an inline system where all of the air circulating through the HVAC system 170 is filtered through the capture device 10 at some point during the circulation process, and a parallel system where are is pulled from the duct work into the capture device 10.

In other embodiments, the method and device described herein may be used as a portable filtration device for radon and other contaminants. In these embodiments, the system components as described above may be miniaturized to fit into a mask or respirator. These embodiments may use semipermeable membranes or similar materials to contain the ionic liquid and create a surface for contact between the ionic liquid and the gas stream to be filtered. In other portable embodiments, the system may exist in a variety of scales, from hand-held to trailer-based, in order to filter air for confined spaces of a variety of sizes. This may be applicable in deployable emergency shelters, tents, laboratories, railcars, boats or ships, or other structures, or for automobiles, recreational vehicles, buses, and other similar applications.

In other embodiments, the system, method, and device described herein may be used to capture radon and/or other elements, compounds, molecules, or substances in ionic liquids for storage, transport, analysis, and/or other scientific, industrial, regulatory, or analytical purposes. In these embodiments, the system may use one or more of the methods described herein to dissolve the radon and/or other elements, molecules, or substances in the ionic liquid by exposing the ionic liquid to a gas stream, environment, or atmosphere containing the substance to be captured, at which point the ionic liquid can either be pumped into a storage vessel or degassed into a “trap” for the containment, storage, and/or transport of the radon or other desired substance. In all of the embodiments described herein and those others that may be similar to those described herein, and envisioned as potential embodiments by the inventors, there may be a variety of sensors, processors, and other electronic devices integrated into the system for monitoring, controlling, and otherwise assisting with the operation of the system. While the specific parameters to be controlled and monitored may vary from one embodiment to the next, controllers, monitors, processors, and/or user interfaces may be used to monitor the amount of radon and/or other contaminants present in the inflowing and outflowing gas streams, the flow rate, and/or velocity and/or pressures of both the gasses and ionic liquid circulation systems, the temperature and pressure of the system, along with many other possible parameters, conditions, and settings.

In some embodiments, the intended use of the invention is as an ionic liquid filter for a gas stream resulting from the combustion or vaporization of organic material, liquid, or other elements or compounds, intended for inhalation. In these embodiments, the gas stream may be bubbled through the ionic liquid or it may encounter the ionic liquid in a scrubber, stripper, bubble column, sparger, or any of the myriad of other potential gas-liquid contact methods disclosed supra. In this embodiment, the ionic liquid may be contained in cartridges or other expendable or replaceable media.

In some embodiments, the intended use of the invention is for the control, capture, mitigation, and/or disposal of fumes, gasses, particulates, pathogens, or other unwanted or harmful substances, in, for example, a laboratory, research facility, industrial facility, fireplace, cooking device, kitchen, or other location where a vent hood or fume hood might be present. In these embodiments, the invention is intended to capture fumes without the need for external venting of a gas stream. This embodiment of the invention may implement any or all of the various methods disclosed supra for the capture of gasses and particulates. In some of these embodiments, the ionic liquid may be circulated through a system of hoses or pipes to an external degassing chamber, or the ionic. liquid may circulate into a container for later degassing of the harmful or unwanted fumes and gasses and filtration of particulates. This embodiment may also be used as part of or the entirety of the filtration system for an atmospheric containment device, such as a glove box, vacuum chamber, biosafety cabinet, or similarly situated devices.

In all of the embodiments of this invention, the ionic liquid may be mixed with a variety of other possible compounds, chemicals, elements, or materials intended to enhance or induce certain effects or properties, or create new properties or effects that may be desired depending on the intended application. Some exemplary compounds, chemicals, materials, and substances along with their intended effects or uses are: scents or oils for air freshening and odor control; anti-bacterial or anti-viral elements or compounds for health protection; minerals or engineered nanomaterials for sorptive or electromagnetic behavior; amino acids or proteins for biochemical reactivity; acid-base or oxidation-reduction reactants for buffering capacity; other ions for ion exchange. This list is purely exemplary and is not limiting in any way.

What is claimed:

1. A device for the dissolution of radon into an ionic liquid comprising:
a volume of ionic liquid and means for contacting said ionic liquid with a volume of air containing radon so as to cause the dissolution of radon into the ionic liquid.

2. The device as recited in claim 1 wherein the volume of ionic liquid is situated within an enclosure having both an inlet port and an outlet port for movement of the volume of air containing radon through the enclosure by means for the movement of air; and
the inlet port for the movement of the volume of air containing radon through the enclosure is connected to means for diffusion of air into a liquid, with said means for the diffusion of air into a liquid being submerged within the volume of ionic liquid situated within the enclosure; and
the enclosure having an inflow port and an outflow port for the circulation of the ionic liquid by a pump between the enclosure and a chamber for degassing the ionic liquid; and
the chamber for degassing the ionic liquid having both an inlet port and an outlet port for the movement of a second volume of air through the chamber, with said second volume of air containing less radon than the volume of air containing radon that is moved through the enclosure.

3. The device as recited in claim 1 wherein the volume of ionic liquid is contacted with the volume of air containing radon by means for gas scrubbing to cause dissolution of the radon into the ionic liquid; and
the means for gas scrubbing is located within an enclosure having both an inlet port and an outlet port for the movement of air containing radon through the enclosure by means for the movement of air; and
the enclosure having an inflow port and an outflow port for the circulation of the ionic liquid by a pump between the enclosure and a chamber for degassing the ionic liquid; and
the chamber for degassing the ionic liquid having both an inlet port and an outlet port for the movement of a second volume of air through the chamber, with said second volume of air containing less radon than the volume of air containing radon that is moved through the enclosure.

4. The device as recited in claim 3 wherein the enclosure containing means for gas scrubbing contains packing materials for increasing the phase interface surface area between the ionic liquid and the volume of air containing radon, thus increasing the efficiency of the dissolution of radon into the ionic liquid.

5. The device as recited in claim 1 wherein the volume of ionic liquid is encapsulated into multiple gas-permeable capsules of a liquid, such that it is not free flowing, and is situated within a packed-bed through which the volume of air containing radon is moved by means for the movement of air, and the encapsulated ionic liquid is degassed of radon by switching the air flowing through the packed-bed to a second volume of air containing less radon than the volume of air containing radon that is being filtered.

6. The device as recited in claim 2 wherein the device is integrated with an air conditioning system such that the device claimed herein removes radon from the same volume of air that is circulated by the air conditioning system.

7. The device as recited in claim 3 wherein the device is integrated with an air conditioning system such that the device claimed herein removes radon from the same volume of air that is circulated by the air conditioning system.

8. The device as recited in claim 5 wherein the device is integrated with an air conditioning system such that the device claimed herein removes radon from the same volume of air that is circulated by the air conditioning system.

9. A method for dissolving radon in an ionic liquid, the method comprising:
Contacting a volume of air containing radon with a volume of ionic liquid by means for contacting a volume of air with a liquid.

10. The method as recited in claim 9 additionally comprising:
providing an enclosure for contacting the ionic liquid with the volume of air containing radon, with said enclosure having both an inlet port and an outlet port for moving the volume of air containing radon through the system by means for the movement of air; and
providing means for diffusion of air into a liquid, connecting said means of diffusion to the inlet port for the movement of air containing radon through the system, and situating said means for diffusion so that it is submerged in the volume of ionic liquid within the enclosure; and
providing the enclosure with an inflow port and an outflow port for circulating the ionic liquid between the enclosure and a degassing chamber using a pump; and
providing the degassing chamber with an inlet port and an outlet port for the movement of a second volume of air through the degassing chamber, with the second volume of air containing less radon than the volume of air containing radon that is moved through the enclosure in order to degas the ionic liquid of a portion of the radon.

11. The method as recited in claim 9 additionally comprising:
contacting the volume of ionic liquid with the volume of air by means for gas scrubbing; and
providing an enclosure to locate said means for gas scrubbing within, with said enclosure having both an inlet port and an outlet port for moving the volume of air containing radon through the enclosure; and
providing the enclosure with an inflow port and an outflow port for circulating the ionic liquid between the enclosure and a degassing chamber in which the ionic liquid is degassed of radon by means for degassing.

12. The method as recited in claim 11 additionally comprising having packing materials within the enclosure to increase the phase interface surface area between the volume of ionic liquid and the volume of air containing radon.

13. The method as recited in claim 9 further comprising:
Encapsulating the volume of ionic liquid into multiple air-permeable capsules and locating those capsules within a packed-bed; and
moving the volume of air containing radon through the packed bed by means for the movement of air to cause dissolution of radon into the encapsulated ionic liquid; and
degassing the encapsulated ionic liquid of radon by switching the volume of air flowing through the packed-bed to a second volume of air containing less radon than the volume of air containing radon.

14. The method as recited in claim 10 further comprising integrating the method for dissolving radon into an ionic liquid with air conditioning system.

15. The method as recited in claim 11 further comprising integrating the method for dissolving radon into an ionic liquid with air conditioning system.

16. The method as recited in claim 13 further comprising integrating the method for dissolving radon into an ionic liquid with air conditioning system.

17. A method for filtering radon, pollutants, impurities and contaminants from a habitable environment comprising:
Providing a volume of ionic liquid in an enclosure; and
contacting the ionic liquid with an air stream from the habitable environment containing radon, pollutants, impurities and contaminants, so as to cause dissolution of the radon, pollutants, impurities and contaminants into the ionic liquid; and
circulating the ionic liquid to a degassing chamber wherein it is contacted with a gas stream containing less radon, pollutants, impurities and contaminants; and
venting to an exterior environment the gas stream into which the radon, pollutants, impurities and contaminants were degassed, then returning the degassed ionic liquid to the enclosure repeat the process.
